(19) United States
(12) Patent Application Publication
(10) Pub. No.: US 2026/0103064 A1
(43) Pub. Date: Apr. 16, 2026

(54) BATTERY MODULE LOCKING STRUCTURE AND METHOD

(71) Applicant: GM GLOBAL TECHNOLOGY OPERATIONS LLC, Detroit, MI (US)

(72) Inventors: Luke Barton, Northville, MI (US); Kevin James Lapprich, Sterling Heights, MI (US); Julian Roy Sherborne, South Lyon, MI (US)

(73) Assignee: GM GLOBAL TECHNOLOGY OPERATIONS LLC, Detroit, MI (US)

(21) Appl. No.: 18/914,948

(22) Filed: Oct. 14, 2024

(51) Int. Cl. B60K 1/04; B60L 50/64

(52) U.S. Cl. CPC B60K 1/04; B60L 50/64; B60K 2001/0438; B60K 2001/0472

(57) ABSTRACT

Methods and systems for securing battery modules in vehicles are provided. A method includes providing a bay in the vehicle adjacent to a vehicle component; inserting the battery module into the bay, wherein the battery module has a wall and wherein the wall is spaced from the vehicle component by a gap; and actuating a locking implement to move from a passive configuration to an active configuration in which the locking implement extends between the battery module and vehicle component to prevent movement of the battery module relative to the vehicle component.

### INTRODUCTION

The disclosure relates generally to electric drive vehicles, including full electric and hybrid electric configurations. More specifically, aspects of this disclosure relate to mounting architectures for battery packs of battery electric vehicles (BEV).

Vehicles typically include chassis frames and body structures designed to support a multitude of vehicle components and contribute toward vehicle stiffness and strength performance. Examples of frame configurations may include ladder frames, unibody (i.e., semi-monocoque) frames, perimeter frames, and others. Many frames include opposite side rails or rocker panels connected via a multitude of cross members. Projecting forward from the rocker panels may be respective front rails connected via a front cross member, and projecting rearward from the rocker panels may be respective rear rails connected via a rear cross member.

An engine and front suspension may generally be supported by the front rails and proximate cross members. A fuel tank and rear suspension may generally be supported by the rear rails and proximate cross members. The rocker panels and associated cross members may generally support a floor pan, passenger seats, body pillars, and a host of other components and features.

More recently, vehicles may include hybrid vehicles powered via a combination of batteries and a combustion engine. Yet further, all-electric vehicles, or battery electric vehicles (BEV), may operate solely on a battery pack. Such vehicles typically support the weight of the batteries upon the chassis frame and in a variety of locations having sufficient storage space. In order to maintain desired road clearances, the batteries are typically located above the chassis frame. Yet further, the batteries in a single vehicle may require a variety of shapes and sizes in order to utilize available storage space.

Accordingly, there is a need for improvements in battery storage for BEV's and associated structures to support and secure the battery after installation while facilitating installation and removal processes. Furthermore, other desirable features and characteristics of the present disclosure will become apparent from the subsequent detailed description and the appended claims, taken in conjunction with the accompanying drawings and the foregoing technical field and background.

### SUMMARY

In one embodiment, a method for securing a battery module in a vehicle includes providing a bay in the vehicle adjacent to a vehicle component; inserting the battery module into the bay, wherein the battery module has a wall and wherein the wall is spaced from the vehicle component by a gap; and actuating a locking implement to move from a passive configuration to an active configuration in which the locking implement extends between the battery module and vehicle component to prevent movement of the battery module relative to the vehicle component.

In certain embodiments, the method further includes actuating the locking implement to move from the active configuration to the passive configuration by retracting the locking implement out of the gap; and removing the battery module from the bay.

In certain embodiments of the method, the locking implement is mounted to the vehicle component.

In certain embodiments of the method, the vehicle component is a cross beam.

In certain embodiments of the method, the cross beam defines an interior volume, and the locking implement is located in the interior volume in the passive configuration.

In certain embodiments of the method, the cross beam includes an upper end, the battery module includes a laterally-extending upper tab, and inserting the battery module into the bay includes contacting the laterally-extending upper tab to the upper end and supporting the battery module with the cross beam while the locking implement is in the passive configuration.

In certain embodiments of the method, actuating the locking implement includes manipulating an implement actuator overlying the cross beam.

In certain embodiments of the method, manipulating the implement actuator includes rotating the implement actuator about an axis parallel to the bay.

In certain embodiments of the method, the vehicle component is a first vehicle component; the bay is located adjacent to the first vehicle component and to a second vehicle component; the wall is a first wall, and wherein the battery module further includes a second wall; the gap is a first gap located between the first wall and the first vehicle component; a second gap is located between the second wall and the second vehicle component; the locking implement is a first locking implement which contacts the first wall of the battery module in the active configuration; and the method includes actuating a second locking implement to move from a passive configuration to an active configuration in which the second locking implement extends between the battery module and vehicle component to prevent movement of the battery module relative to the vehicle component.

In certain embodiments, the method further includes compressing the battery module between the first locking implement and the second locking implement when the first locking implement and the second locking implement are moved to the respective active configurations.

In certain embodiments of the method, the first wall is a first sidewall; the second wall is second sidewall opposite the first sidewall; a first endwall and a second endwall connect the first sidewall and the second sidewall; the first endwall and second endwall are separated by a side length; the first sidewall and second sidewall are separated by an end length; and the side length is greater than the end length.

In another embodiments, a housing system for a battery module in a vehicle is provided and includes a bay in the vehicle adjacent to a vehicle component configured to receive the battery module with a gap between the battery module and the vehicle component; and a locking implement configured to move from a passive configuration to an active configuration in which the locking implement extends between the battery module and vehicle component to prevent movement of the battery module relative to the vehicle component.

In certain embodiments of the housing system, the locking implement is configured to move from the active configuration to the passive configuration in which the locking implement is not located in the gap.

In certain embodiments of the housing system, the locking implement is mounted to the vehicle component.

In certain embodiments of the housing system, the vehicle component is a cross beam, wherein the cross beam defines an interior volume, and wherein the locking implement is located in the interior volume in the passive configuration.

In certain embodiments of the housing system, the cross beam includes an upper end, wherein the battery module includes a laterally-extending upper tab configured to sit on the upper end.

In certain embodiments of the housing system, the locking implement includes an implement actuator overlying the cross beam, and wherein the locking implement and implement actuator are rotatable about an axis parallel to the bay.

In certain embodiments of the housing system, the vehicle component is a first vehicle component; the bay is located adjacent to the first vehicle component and to a second vehicle component; the gap is a first gap located between the battery module and the first vehicle component; a second gap is located between the battery module and the second vehicle component; the locking implement is a first locking implement; and the housing system includes a second locking implement configured to move from a passive configuration to an active configuration in which the second locking implement extends between the battery module and vehicle component to prevent movement of the battery module relative to the vehicle component.

In another embodiment, a vehicle includes an electric propulsion system; a battery module; a battery module bay adjacent to a vehicle component and configured to receive the battery module with a gap between the battery module and the vehicle component; and a locking implement configured to move from a passive configuration to an active configuration in which the locking implement extends between the battery module and vehicle component to prevent movement of the battery module relative to the vehicle component.

In certain embodiments of the vehicle, the locking implement is configured to move from the active configuration to the passive configuration in which the locking implement is retracted out of the gap; the locking implement is mounted to the vehicle component; the vehicle component is a cross beam defining an interior volume and including an upper end; the locking implement is located in the interior volume in the passive configuration; the battery module includes a laterally-extending upper tab configured to sit on the upper end; the locking implement includes an implement actuator overlying the cross beam; and the locking implement and implement actuator are rotatable about an axis parallel to the battery module bay.

### DESCRIPTION OF THE DRAWINGS

The present disclosure will hereinafter be described in conjunction with the following drawing figures, wherein like numerals denote like elements, and wherein:

FIG. 1 is a schematic top view of an embodiment of a vehicle with a powertrain and a battery module using a battery array configured to generate and store electrical energy, according to various embodiments.

FIG. 2 is a schematic top perspective exploded view of the battery module shown in FIG. 1, having a cooling plate configured to distribute a flow of coolant for managing heat transfer from the battery array to the environment, according to various embodiments.

FIG. 3 is an overhead schematic illustrating the location of battery modules in a battery bay, such as in the vehicle of FIG. 1, according to various embodiments.

FIG. 4 is an overhead schematic illustrating the location of a locking mechanism in a passive configuration adjacent to battery modules in a battery bay, such as in the vehicle of FIG. 1, according to various embodiments.

FIG. 5 is an overhead schematic of the locking mechanism of FIG. 4 in an active configuration contacting the battery modules, according to various embodiments.

FIG. 6 is a side view schematic of the locking mechanism of FIG. 4 in the passive configuration, according to various embodiments.

FIG. 7 is a side view schematic of the locking mechanism of FIG. 5 in the active configuration, according to various embodiments.

FIG. 8 is an overhead schematic illustrating the location of a locking mechanism in a passive configuration adjacent to battery modules in a battery bay, such as in the vehicle of FIG. 1, according to various embodiments.

FIG. 9 is an overhead schematic of the locking mechanism of FIG. 8 in an active configuration contacting the battery modules, according to various embodiments.

FIG. 10 is a side view schematic of the locking mechanism of FIG. 8 in the passive configuration, according to various embodiments.

FIG. 11 is a side view schematic of the locking mechanism of FIG. 9 in the active configuration, according to various embodiments.

FIG. 12 is a flow chart illustrating a method for securing a battery in a battery bay of a vehicle, according to various embodiments.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, summary or the following detailed description.

Embodiments of the present disclosure may be described herein in terms of functional and/or logical block components and various processing steps. Connecting lines shown in the various figures contained herein are intended to represent example functional relationships and/or physical couplings between the various elements. It should be noted that many alternative or additional functional relationships or physical connections may be present in an embodiment of the present disclosure.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

Embodiments herein provide for securing a battery module in the battery bay of a vehicle while facilitating installation and removal of the battery module when desired. Specifically, a locking device located in the vehicle and is movable between a passive configuration, in which the locking device is removed from the battery bay, and an active configuration, in which the locking device extends into the battery bay, contacts, and exerts a force against the battery module.

In certain embodiments, the locking device is actuated from a location above vehicle components adjacent to the battery bay that is easily reached by a technician. Further, actuation may include simply rotating a shaft included in or connected to the locking device. Thus, a simplified process with limited design impacts on other functions is provided.

Manufacturing and installation requires load clearance between the battery module and vehicle components so that the battery module may be loaded safely and reliably. During dynamic loading conditions this clearance allows for relative motion between the battery module and the vehicle components which may result in impacts and failure modes such as delamination of the battery cells from the battery module structure. Embodiments herein provide for selectively and reversibly eliminating the clearance between the vehicle components and the battery module. Specifically, certain embodiments provide for rotating or reversibly expanding a locking device to eliminate clearance between battery modules and adjacent vehicle components.

Thus, methods are provided to eliminate clearance between components in an assembly in order to reduce or eliminate relative motion between those components during dynamic loading, such as when the vehicle accelerates, decelerates, or particularly when the vehicle drops or rises vertically due to uneven terrain.

In certain embodiments, the locking device is rotated after the battery module is loaded into the structure. Rotation of the locking device fills the clearance between the battery module and vehicle components. This process is reversible so the module may be removed for service.

In certain embodiments, the locking device is expanded after the battery module is loaded into the structure. Expansion of the locking device fills the clearance between the battery module and vehicle components. The locking device may be deformable so that the locking device may fill a variable amount of initial clearance. This process is reversible so the module may be removed for service.

In certain embodiments, systems and methods herein are provided to maintain existing nominal load-clearance required for manufacturing during installation, selectively fill the clearance between the battery module and vehicle components after installation, and be reversible to the battery module may be removed for service.

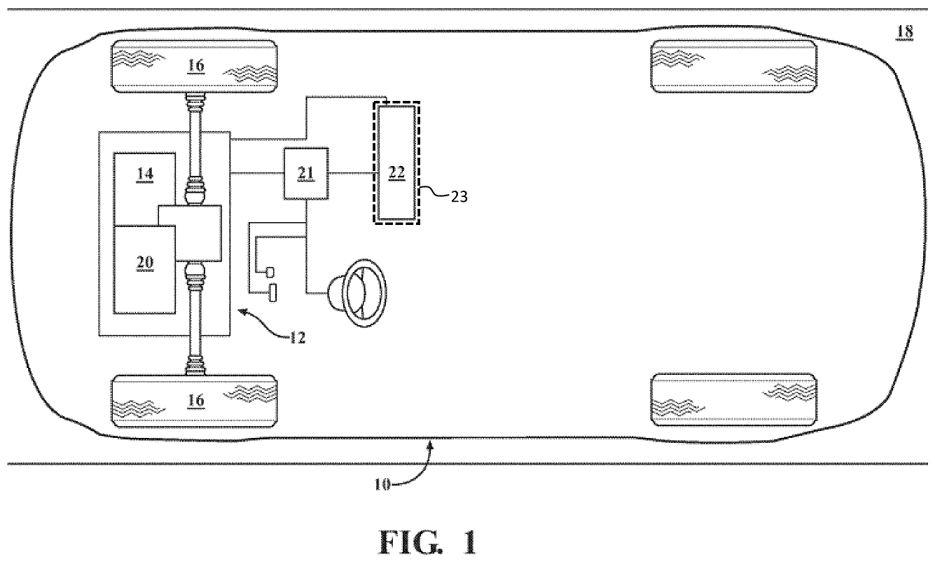

Referring to the drawings, wherein like reference numbers correspond to like or similar components wherever possible throughout the several figures, an electric vehicle 10 is shown in FIG. 1.

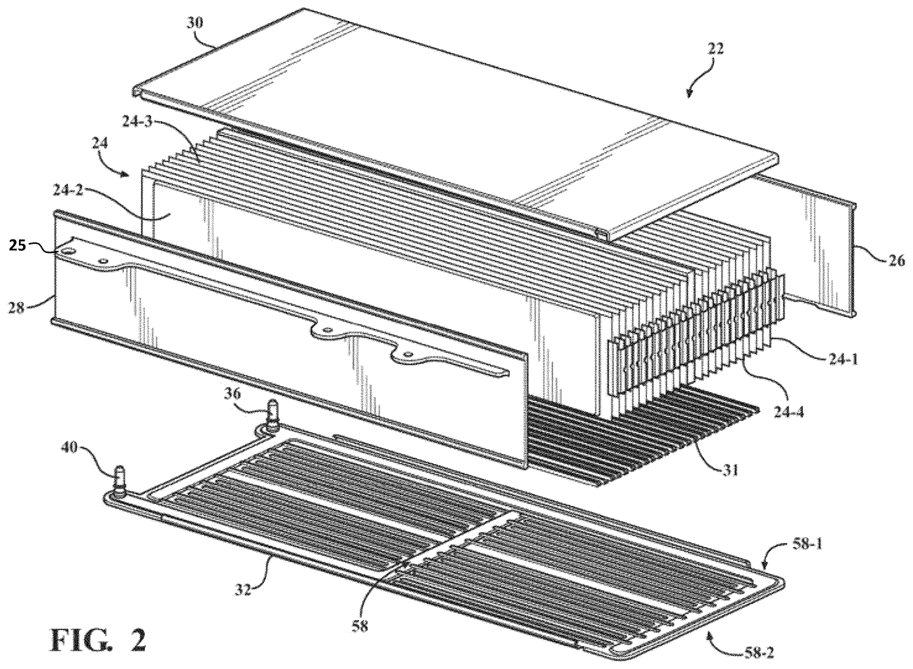

Cross-referencing FIGS. 1-2, the vehicle 10 has a power train or electric propulsion system 12. FIG. 1 illustrates the electric vehicle 10 as an automobile, such as any one of a number of different types of automobiles, such as, for example, a sedan, a wagon, a truck, sport utility vehicle (SUV), or the like. In certain implementations, the vehicle 10 may comprise a motorcycle or other land-based vehicle, such as a rail locomotive, or a non-land-based vehicle such as aircraft, spacecraft, watercraft, and so on, and/or one or more other types of mobile platforms (e.g., a robot and/or another mobile platform). In yet other implementations, the battery module described below may instead be part of and/or coupled to any number of other types of platforms and/or other systems, moving or non-moving, such as a building, infrastructure, secondary use, home power, non-automotive, and/or other platforms and/or other systems.

The propulsion system 12 includes a power-source 14 configured to generate a power-source torque for propulsion of the vehicle 10 via driven wheels 16 relative to a road surface 18. The power-source 14 is depicted as an electric motor-generator. The propulsion system 12 may also include an additional power-source 20, such as an internal combustion engine. The power-sources 14 and 20 may act in concert to power the vehicle 10. The vehicle 10 also includes a programmable electronic controller 21 and a battery module 22. The battery module 22 may include one or more battery sections 24, such as cells or arrays, configured to generate and store electrical energy for powering the power-sources 14 and 20. Each battery section 24 in the battery module 22 generates and stores electrical energy through heat-producing electro-chemical reactions. Operation of the propulsion system 12 and the battery module 22 may generally be regulated by the electronic controller 21.

As shown in FIG. 1, the battery module 22 is located within a battery bay 23. The battery bay 23 is an open space bounded by other vehicle components in which the battery module 22 may be located and supported. In certain embodiments, a top end of the battery module 22 is fixed to the vehicle components while the bottom end of the battery module 22 is not directly supported. Thus, the battery module 22 hangs from the vehicle components.

As shown in FIG. 2, the battery section 24 has a first side surface 24-1, a second side surface 24-2, a top surface 24-3, and a bottom surface 24-4. The battery module 22 includes a first side plate or sidewall 26, a second side plate or sidewall 28, and a cover or top wall 30 attached to the first and second side plates. The first side plate 26, the second side plate 28, and the cover 30 are configured to bound the battery section 24 on the respective first side surface 24-1, second side surface 24-2, and top surface 24-3. As additionally shown in FIG. 2, an epoxy layer 31 may be applied to the bottom surface 24-4 of the battery section 24. The battery module 22 also includes a bottom wall 32 or bottom plate 32. In certain embodiments, the bottom plate 32 is a plate cooling plate 32 configured to manage heat transfer from the battery section 24 to the environment. The cooling plate 32 is attached to the first and second side plates 26, 28 to thereby bound the battery section 24 on the bottom surface 24-4. The cooling plate 32 may be additionally affixed to the bottom surface 24-4 of the battery section 24 via the epoxy layer 31.

As indicated in FIG. 2, each side plate 26 and 28 is formed with outwardly-extending tabs 25. During installation in the vehicle 10, the tabs 25 may be located on, and fixed to, adjacent vehicle components as described below. Thus, the battery module 22 may be supported by the tabs 25 when installed in a vehicle 10.

The cooling plate 32 is configured to accept a flow of circulating coolant therethrough to remove heat produced by the battery section 24. To that end, as shown in FIG. 2, the cooling plate 32 includes a coolant inlet 36. The cooling plate 32 also includes a coolant outlet 40. Coolant channels are arranged in direct fluid communication with the coolant inlet 36 and/or coolant outlet 40.

As shown in FIG. 2, the cooling plate 32 may have a clamshell construction 58. The clamshell construction 58 may include two sub-plates 58-1, 58-2 fused together and configured to define the respective coolant channels.

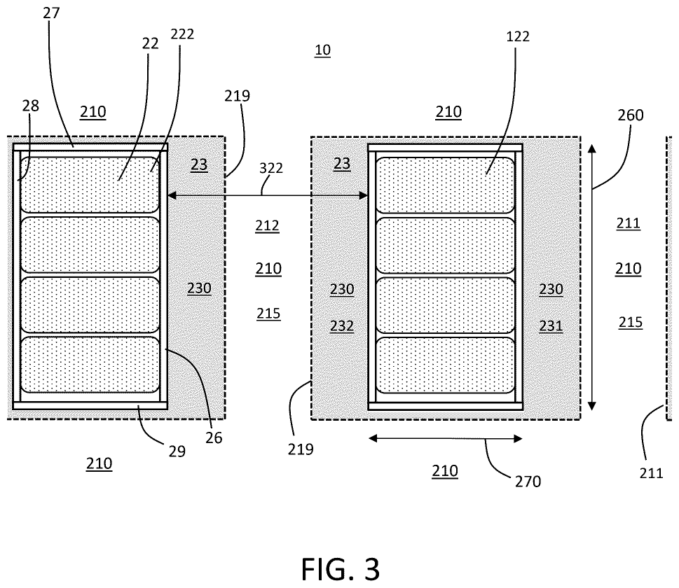

FIG. 3 is an overhead schematic view of a portion of battery modules 22 received within a portion of a battery bay 23 or bays 23. It is noted that the tabs 25 and top wall or cover 30 are not shown. In FIG. 3, a first battery module 122 and a second battery module 222 are identified. First and second battery modules 122 and 222 may be considered to be part of a single battery module 22 or may be considered to be separate modules.

As shown, the battery bay 23 is bordered by vehicle components 210. For example, vehicle components 210 may include adjacent systems to which the battery module is not structurally connected, and adjacent structural components to which the battery is structurally connected. For example, two cross beams 215 may extend through the battery bay 23 as shown. In certain embodiments, the tabs (not shown) may rest on, and be fixed to, the top surfaces of the cross beams 215. In other words, the battery modules 22 may be structurally connected to the cross beams 215.

An interface 219 is defined where the battery bay 23 meets the vehicle components 210.

As shown in FIG. 3, each battery module 22 includes a first end plate or endwall 27 and a second end plate or endwall 29. The first endwall 27 and second endwall 29 connect the first sidewall 26 and second sidewall 28. As shown, the outer surfaces of the first endwall 27 and second endwall 29 are separated by a side length 260 and the outer surfaces of the first sidewall 26 and second sidewall 28 are separated by an end length 270. In certain embodiments, the side length 260 is greater than the end length 270.

For example, the side length 260 may be form 0.5 to 2 meters, such as 1.2 meters. The end length 270 may be significantly less, such as from 50 to 500 millimeters (mm).

As shown in FIG. 3, gaps 230 are located between the battery module 22 and the vehicle components 210. The gaps 230 may facilitate installation of the battery module 22 into the bay 23 without obstruction by the vehicle components 210.

FIG. 3 indicates that a first gap 231 is located between first sidewall 26 of first battery module 221 and vehicle component 211, which may be a cross beam 215, and a second gap 232 is located between second sidewall 28 of first battery module 221 and vehicle component 212, which may be a cross beam 215.

As shown in FIG. 3, a vehicle component 212, such as a cross beam 215 may be located between two battery modules, such as modules 122 and 222. As shown, the sidewall 26 of module 222 is distanced from the sidewall 28 of module 122 by a distance 322. The cross beam 215 has a width less than the distance 322, such that gaps 230 are located between the cross beam 215 and the modules 122 and 222.

Gaps 230 are further provided between end wall 27 and vehicle component 210, between end wall 29 and vehicle component 210, and/or between bottom wall (not shown in FIG. 3) and vehicle component 210. As indicated above in relation to FIG. 2, laterally-extending tabs 25 may contact, and be fixed to, upper surfaces of vehicle components 210 to support the battery modules 22 in the bays 23.

While the gaps 230 may facilitate installation, the absence of additional structural contact, beyond the tabs 25, between the battery modules 22 and the vehicle components 210 may lead to undesirable results. For example, the weight of the battery modules 22 and high velocities of the vehicle may cause the battery modules 22 to exhibit large amounts of momentum during vehicle use. In certain embodiments, a battery module may weigh over 200 pounds, over 300 pounds, or over 400 pounds, such as about 450 pounds. When acceleration or deceleration occurs, the momentum of the non-supported bottom portions of the battery modules may cause the battery modules to swing. If not stopped or damped, the battery modules may swing back and forth like a pendulum. Such swinging may lead to repeated impacts between the battery modules 22 and the vehicle components 210 and lead to delamination of battery modules 22 or other detrimental structural effects.

With the understanding of the relative locations of the battery modules 22, bays 23, and vehicle components 210 explained in FIG. 3, the following figures illustrates the use of a locking implement in a housing system to prevent undesirable movement of the battery modules 22 relative to the vehicle components 210.

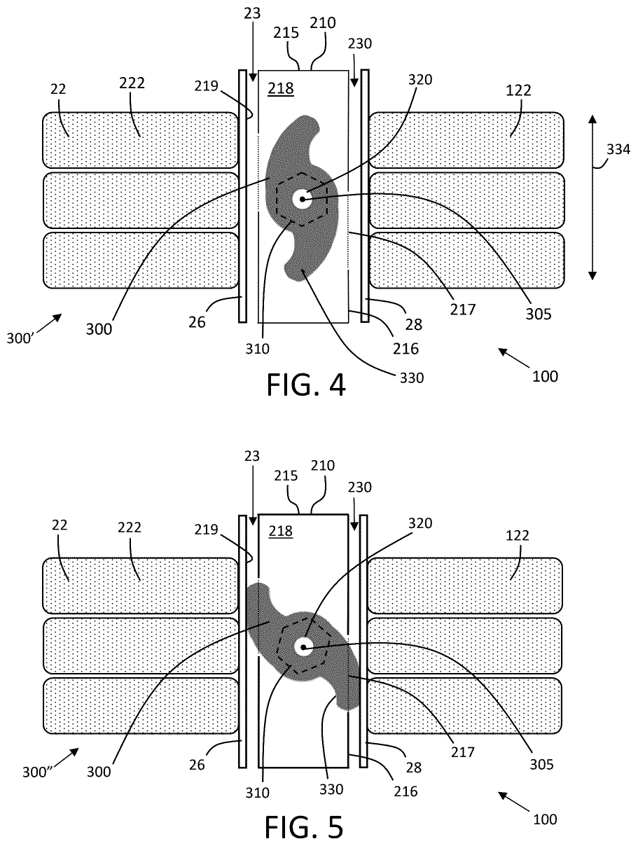

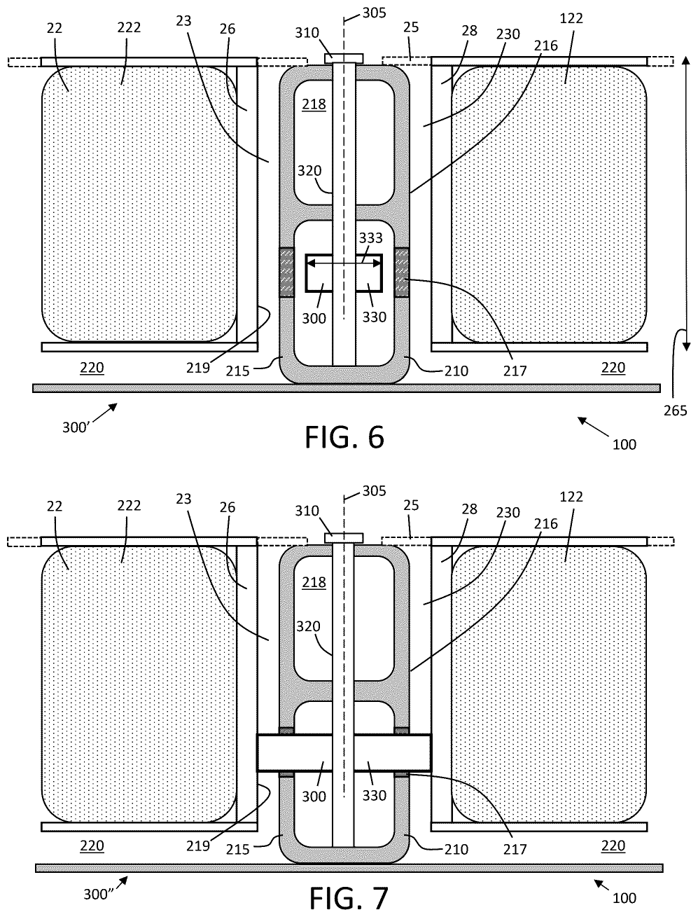

FIG. 4 is an overhead schematic view and FIG. 6 is a side schematic view of a housing system 100 focused on a vehicle component 210 in the form of a cross beam 215 located in the bay 23 between two battery modules 122 and 222.

Cross-referencing FIGS. 4 and 6, the vehicle component 210 has an outer surface 216 that defines an interior volume 218. The outer surface 216 of the vehicle component 210 is spaced from the sidewall 26 of the battery module 222, i.e., from interface 219, and from the sidewall 28 of the battery module 122, i.e., from interface 219, by gaps 230. The outer surface 216 is formed with openings 217. As further shown in FIG. 6, the bottom wall 32 of each battery modules 22 is distanced from a lower vehicle component 210 by gaps 230.

FIGS. 4 and 6 illustrate that the housing system 100 includes a locking implement 300. In FIGS. 4 and 6, the locking implement 300 is in a passive configuration 300′. In the passive configuration 300′, the locking implement 300 is located within the interior volume 218 of the vehicle component 210. Specifically, no portion of the locking implement 300 is located in the gap 230.

In FIGS. 4 and 6, the locking implement 300 includes an implement actuator 310 that may be manipulated to move the locking implement 300 from the passive configuration 300′ to an active configuration. Further, the locking implement 300 includes a shaft 320 and a laterally-extending member 330. The shaft 320 may rotate about an axis 305. In FIGS. 4 and 6, the implement actuator 310, shaft 320, and laterally-extending member 330 are fixed together and rotate about the axis 305 together.

The laterally-extending member 330 may be a cam, eccentric disk, or other shape configured to convert rotary motion into linear motion. For example, as shown in FIG. 6, the laterally-extending member 330 extends in the direction toward each sidewall 26, 28, i.e., in the plane of FIG. 6, for a distance 333. In FIG. 4, the laterally-extending member 330 extends in the direction parallel to each sidewall 26, 28, for a distance 334. As shown, distance 334 is greater than distance 333. Further, distance 334 is greater than distance 322 between modules 122 and 222.

FIG. 6 illustrates that tabs 25 extending laterally from the modules 122 and 222 may extend over and rest on the vehicle component 210. Further, the tabs 25 may be fixed to the vehicle component 210, such as by a removable fastener. Typically, a battery module 22 may be supported by at least four tabs 25, with two on each opposite side. For longer battery modules, more than four tabs 25 may provide for structural connection to the vehicle components 210.

FIG. 6 further illustrates that the outer surfaces of top wall 30 and bottom wall 32 are distanced from one another by a module height 265. In certain embodiments, the module height 265 may be from 100 to 400 millimeters (mm) such as from 200 to 300 mm, such as about 250 mm.

FIGS. 5 and 7 illustrate the housing system 100 with the locking implement 300 in an active configuration 300″. FIG. 5 is an overhead schematic view and FIG. 7 is a side schematic view of a housing system 100 focused on a vehicle component 210 in the form of a cross beam 215 located in the bay 23 between two battery modules 122 and 222.

Cross-referencing FIGS. 5 and 7, the actuator 310 is manipulated and rotated about axis 305 from the passive configuration to the active configuration 300″. In certain embodiments, the actuator 310 may be a handle, nut, or other fastener head that may be manipulated by hand or by a tool and rotated about axis 305.

In the active configuration 300″, the laterally-extending member 330 extends laterally through the opening 217 in the cross beam 215 and into the gaps 230 until contacting and pressing against the sidewalls 26 and 28 of the modules 222 and 122. Friction between the cross beam 215 and the shaft 320 may hold the locking implement 300 in position in the active configuration 300″.

The shaft 320 may be rotated in the opposite direction to retract the laterally-extending member 330 from the gaps 230 and to receive the laterally-extending member 330 within the interior volume 218 of the vehicle component 210, returning to the passive configuration 300′ of FIGS. 4 and 6.

As shown in FIG. 4-7, the locking device 300 may have an asymmetric shape around an axial center, such as a cam, so that 90 degree rotation causes the locking device 300 to fill the clearance gap between the battery module 22 and the adjacent vehicle structure. In certain embodiments, the locking device 300 includes a laterally-extending member 330 that is deformable so that the laterally-extending member 330 may fill a wide range of clearance by “flattening out” after contacting the mating component of the battery module 22, i.e., a wall or plate of the battery module 22. In certain embodiments, the laterally-extending member 330 is formed from a selected material and with a selected geometric shape which combine to tune in the strain/force curve of the deformation. In certain embodiments, the locking device 300 and/or laterally-extending member 330 is integrated into the vehicle components 210 defining the battery bay 23 and is expanded in place to reduce the clearance to, or to contact, the battery module 22. In certain embodiments, the locking device 300 and/or laterally-extending member 330 is integrated into the battery module 22 and is expanded in place to reduce the clearance to, or to contact, the vehicle components 210 defining the battery bay 23.

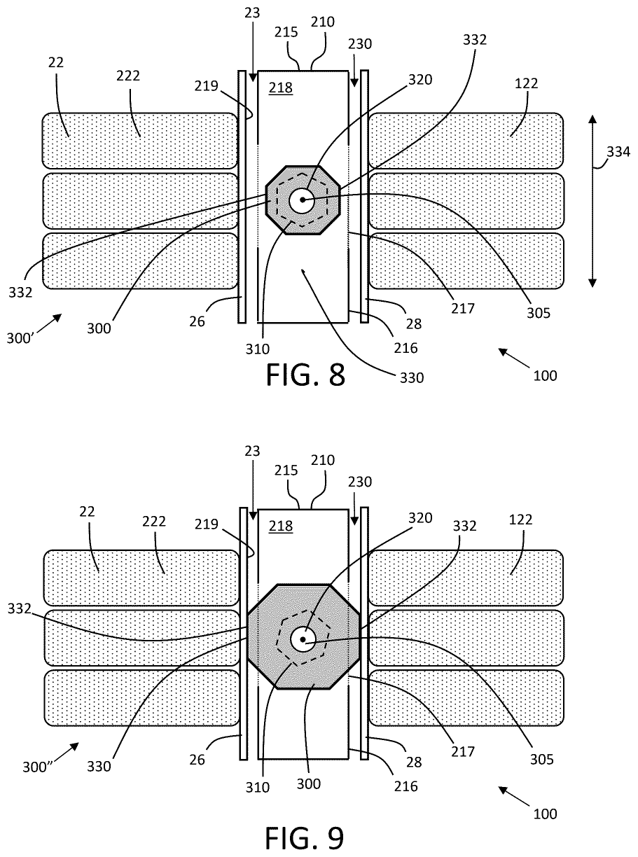

Referring now to FIGS. 8-11, a housing system 100 is illustrated.

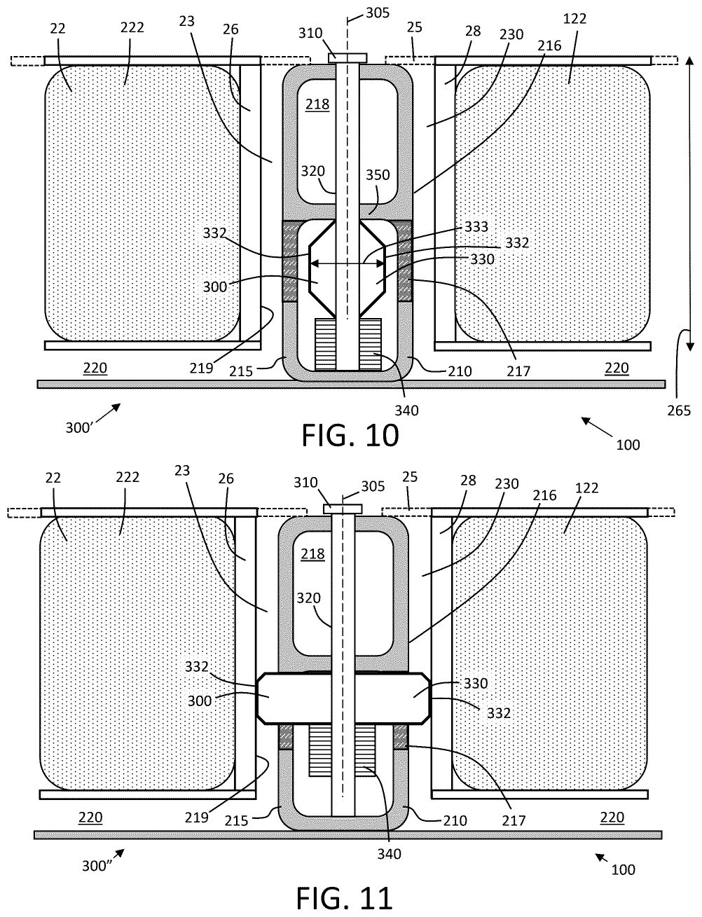

FIG. 8 is an overhead schematic view and FIG. 10 is a side schematic view of a housing system 100 focused on a vehicle component 210 in the form of a cross beam 215 located in the bay 23 between two battery modules 122 and 222.

Cross-referencing FIGS. 8 and 10, the vehicle component 210 has an outer surface 216 that defines an interior volume 218. The outer surface 216 of the vehicle component 210 is spaced from the sidewall 26 of the battery module 222, i.e., from interface 219, and from the sidewall 28 of the battery module 122, i.e., from interface 219, by gaps 230. The outer surface 216 is formed with openings 217. As further shown in FIG. 10, the bottom wall 32 of each battery modules 22 is distanced from a lower vehicle component 210 by gaps 230.

FIG. 10 illustrates that tabs 25 extending laterally from the modules 122 and 222 may extend over and rest on the vehicle component 210. Further, the tabs 25 may be fixed to the vehicle component 210, such as by a removable fastener. Typically, a battery module 22 may be supported by at least four tabs 25, with two on each opposite side. For longer battery modules, more than four tabs 25 may provide for structural connection to the vehicle components 210.

FIG. 10 further illustrates that the outer surfaces of top wall 30 and bottom wall 32 are distanced from one another by a module height 265.

FIGS. 8 and 10 illustrate that the housing system 100 includes a locking implement 300. In FIGS. 8 and 10, the locking implement 300 is in a passive configuration 300′. In the passive configuration 300′, the locking implement 300 is located within the interior volume 218 of the vehicle component 210. Specifically, no portion of the locking implement 300 is located in the gap 230.

In FIGS. 8 and 10, the locking implement 300 includes an implement actuator 310 that may be manipulated to move the locking implement 300 from the passive configuration 300′ to an active configuration. Further, the locking implement 300 includes a shaft 320 and a laterally-extending member 330. The shaft 320 may rotate about an axis 305. In FIGS. 8 and 10, the implement actuator 310 and shaft 320 are fixed together and rotate about the axis 305 together. The laterally-extending member 330 may be fixed to the shaft 320 and rotate with the shaft 320. Alternatively, the shaft 320 may pass through the laterally-extending member 330 and may be free to rotate independently of the laterally-extending member 330.

The laterally-extending member 330 is a device that translates longitudinal force (along axis 305) to a lateral force (perpendicular to axis 305). For example, the laterally-extending member 330 may be a leaf spring device, a structural balloon, or other device that converts a compression force in a longitudinal direction to an expansion force in a lateral direction. In certain embodiments, the laterally-extending member 330 converts the longitudinal compression force to a radial force extending in all directions, including toward the sidewalls 26 and 28. In other embodiments, the laterally-extending member 330 converts the longitudinal compression force to a linear force toward the sidewalls 26 and 28, i.e., a non-radial force. In each case, surfaces 332 of the laterally-extending member 330 are driven outward from one another and into contact with the sidewalls 26 and 28.

As shown in FIG. 10, in the passive configuration, the laterally-extending member 330 extends in the direction toward each sidewall 26, 28, i.e., in the plane of FIG. 10, for a distance 333.

FIG. 10 further illustrates that the housing system 100 includes a movable compression block 340 and a stationary compression block 350. A threaded interconnection between the shaft 320 and the compression block 340 is provided. The shaft 320 may pass through the stationary compression block 350, but the shaft 320 is not connected to the stationary compression block 350. As a result, rotation of the actuator 310 and shaft 320 causes movement of the movable compression block 340. Specifically, from the passive configuration 300′ of FIGS. 8 and 10, rotation of the shaft 320 would cause movement of the movable compression block 340 toward the stationary compression block 350.

FIGS. 9 and 11 illustrate the housing system 100 with the locking implement 300 in an active configuration 300″, i.e., after movement of the movable compression block 340 toward the stationary compression block 350. FIG. 9 is an overhead schematic view and FIG. 11 is a side schematic view of a housing system 100 focused on a vehicle component 210 in the form of a cross beam 215 located in the bay 23 between two battery modules 122 and 222.

Cross-referencing FIGS. 9 and 11, the actuator 310 is manipulated and rotated about axis 305 from the passive configuration to the active configuration 300″. For example, the actuator 310 may be handle, nut, or other fastener head that may be manipulated by a tool and rotated about axis 305.

While moving to the active configuration 300″, the laterally-extending member 330 is compressed longitudinally, i.e., along axis 305, and expands laterally or radially. In the active configuration 300″, the laterally-extending member 330 extends laterally through the opening 217 in the cross beam 215 and into the gaps 230 until surfaces 332 contact and press against the sidewalls 26 and 28 of the modules 222 and 122. Friction between the cross beam 215 and the shaft 320 may hold the locking implement 300 in position in the active configuration 300″.

The shaft 320 may be rotated in the opposite direction to move the movable compression block 340 away from the stationary compression block 350 and remove the compression force on the laterally-extending member 330. As a result, the laterally-extending member 330 retracts from the gaps 230 and is received within the interior volume 218 of the vehicle component 210, returning to the passive configuration 300′ of FIGS. 8 and 10.

As shown in FIG. 8-11, the locking device 300 may be a reversibly deformable device that may be expanded by applying a load orthogonal to the lateral direction of expansion and that will laterally retract when the load is removed. In certain embodiments, the laterally-extending member 330 is shaped like a hollow bulb, leaf spring, or another suitable geometry. The laterally-extending member 330 is compressible between a threaded movable compression block 340 and a stationary compression block 350. During rotation of the shaft, a threaded engagement between the shaft 320 and the movable compression block 340 causes the moveable compression block 340 to move relative to the stationary compression block 350, causing the laterally-extending member 330 to expand or retract orthogonal to the direction of the load. In certain embodiments, the laterally-extending member 330 may fill a wide range of clearances by being deformable and flattening out after contacting the mating component, i.e., wall or plate of the battery module 22. In certain embodiments, the locking device 300 is integrated into the vehicle component 210 adjacent to the battery bay 23 and is expanded in place to reduce the clearance to, or to contact, the battery module 22. In certain embodiments, the locking device 300 is integrated into the battery module 22 and is expanded in place to reduce the clearance to, or to contact, the vehicle component 210 adjacent to the battery bay 23.

Cross-referencing FIG. 3, FIGS. 4-7, and FIGS. 8-11, it may be understood that a battery module 22 may be located between two vehicle components 210 provided with locking implements 300. Thus, manipulating each locking implement 300 to the active configuration 300″ causes the battery module 22 to be compressed between laterally-extending members 330 from opposite sides of the module 22. Further, more than one locking implement 300 may be provided along the length of a battery module 22, such that each battery module 22 may be contacted by at least four locking implements 300 in the active configuration 300″, with two on each opposite side. Longer battery modules 22 could be provided with six, eight, ten, or more locking implements 300 arranged to secure the battery module 22 in place and to resist movement relative to the vehicle despite acceleration/deceleration of the vehicle.

It is noted that while FIGS. 4-7 and FIGS. 8-11 illustrate contact between the locking implement 300 and sidewalls 26 and 28 of the battery module 22, in certain embodiments, the end walls or bottom wall of the battery module 22 may be contacted and pressed by the locking implement 300.

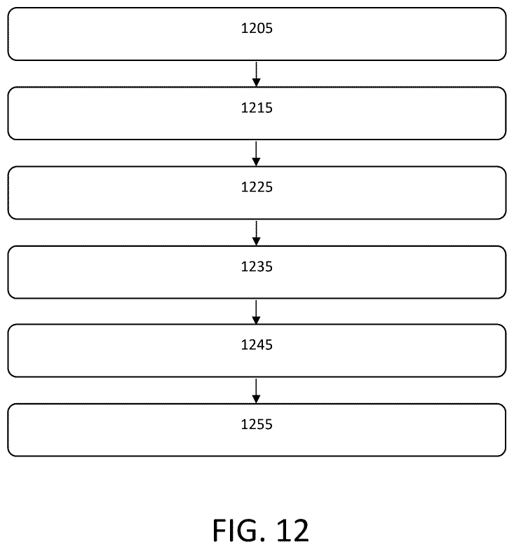

FIG. 12 is a flow chart illustrating a method 1200 for locating a battery module in a vehicle. As shown, method 1200 includes providing a vehicle 10 with a battery bay 23 and housing assembly 100 in a passive configuration 300′, at action block 1205.

Method 1200 may continue at action block 1215 with installing a battery module 22 in the battery bay 23. For example, the battery module 22 may be lowered into the bay 23 until the tabs 25 rest on a structural vehicle component 210. Then, the tabs 25 may be fixed to the structural vehicle component 210, such as by removable fasteners.

With the battery module 22 fixed in position in the battery bay 23, method 1200 may continue at action block 1225 with actuating locking implements 300 to move the locking implements 300 to respective active configurations 300″. In the active configurations 300″, laterally-extending members 330 of the locking implements 300 contact and apply a lateral force against selected walls of the battery module 22. For example, compressive lateral forces may be applied against opposite sidewalls 26 and 28 of the battery module 22. As a result, relative movement of the battery module 22 with respect to the vehicle component 210 is prevented or inhibited.

At action block 1235, method 1200 includes operating the vehicle 10. While operating the vehicle 10, locking implements 300 prevent movement of the battery module 22 with respect to the vehicle component 210. More specifically, the locking implements 300 prevent impacts between the battery module 22 and the vehicle component 210 despite events in which large inertial forces are applied to the battery module 22.

Method 1200 may include, at action block 1245, actuating the locking implement 300 to the passive configuration 300′. As described above, the locking implement is easily retracted out of contact with the battery assembly 22 and removed from the battery bay 23. As a result, the battery bay 23 is provided with full clearance to facilitate removal of the battery module 22 when desired.

Method 1200 may include, at action block 1255, removing the battery module 22 from the battery bay 23. For example, the battery module 22 may be removed for diagnostics and or replacement. Method 1200 may then be repeated at action block 1205.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for securing a battery module in a vehicle, the method comprising:
providing a bay in the vehicle adjacent to a vehicle component;
inserting the battery module into the bay, wherein the battery module has a wall and wherein the wall is spaced from the vehicle component by a gap; and
actuating a locking implement to move from a passive configuration to an active configuration in which the locking implement extends between the battery module and vehicle component to prevent movement of the battery module relative to the vehicle component.

2. The method of claim 1, further comprising:
actuating the locking implement to move from the active configuration to the passive configuration by retracting the locking implement out of the gap; and
removing the battery module from the bay.

3. The method of claim 1, wherein the locking implement is mounted to the vehicle component.

4. The method of claim 3, wherein the vehicle component is a cross beam.

5. The method of claim 4, wherein the cross beam defines an interior volume, and wherein the locking implement is located in the interior volume in the passive configuration.

6. The method of claim 5, wherein the cross beam includes an upper end, wherein the battery module includes a laterally-extending upper tab, and wherein inserting the battery module into the bay comprises contacting the laterally-extending upper tab to the upper end and supporting the battery module with the cross beam while the locking implement is in the passive configuration.

7. The method of claim 6, wherein actuating the locking implement comprises manipulating an implement actuator overlying the cross beam.

8. The method of claim 7, wherein manipulating the implement actuator comprises rotating the implement actuator about an axis parallel to the bay.

9. The method of claim 1, wherein:
the vehicle component is a first vehicle component;
the bay is located adjacent to the first vehicle component and to a second vehicle component;
the wall is a first wall, and wherein the battery module further includes a second wall;
the gap is a first gap located between the first wall and the first vehicle component;
a second gap is located between the second wall and the second vehicle component;
the locking implement is a first locking implement which contacts the first wall of the battery module in the active configuration; and
the method comprises actuating a second locking implement to move from a passive configuration to an active configuration in which the second locking implement extends between the battery module and vehicle component to prevent movement of the battery module relative to the vehicle component.

10. The method of claim 9, further comprising compressing the battery module between the first locking implement and the second locking implement when the first locking implement and the second locking implement are moved to the respective active configurations.

11. The method of claim 9, wherein:
the first wall is a first sidewall;
the second wall is second sidewall opposite the first sidewall;
a first endwall and a second endwall connect the first sidewall and the second sidewall;
the first endwall and second endwall are separated by a side length;
the first sidewall and second sidewall are separated by an end length; and
the side length is greater than the end length.

12. A housing system for a battery module in a vehicle, the housing system comprising:
a bay in the vehicle adjacent to a vehicle component configured to receive the battery module with a gap between the battery module and the vehicle component; and
a locking implement configured to move from a passive configuration to an active configuration in which the locking implement extends between the battery module and vehicle component to prevent movement of the battery module relative to the vehicle component.

13. The housing system of claim 12, wherein the locking implement is configured to move from the active configuration to the passive configuration in which the locking implement is not located in the gap.

14. The housing system of claim 13, wherein the locking implement is mounted to the vehicle component.

15. The housing system of claim 14, wherein the vehicle component is a cross beam, wherein the cross beam defines an interior volume, and wherein the locking implement is located in the interior volume in the passive configuration.

16. The housing system of claim 15, wherein the cross beam includes an upper end, wherein the battery module includes a laterally-extending upper tab configured to sit on the upper end.

17. The housing system of claim 16, wherein the locking implement comprises an implement actuator overlying the cross beam, and wherein the locking implement and implement actuator are rotatable about an axis parallel to the bay.

18. The housing system of claim 17, wherein:
the vehicle component is a first vehicle component;
the bay is located adjacent to the first vehicle component and to a second vehicle component;
the gap is a first gap located between the battery module and the first vehicle component;
a second gap is located between the battery module and the second vehicle component;
the locking implement is a first locking implement; and
the housing system comprises a second locking implement configured to move from a passive configuration to an active configuration in which the second locking implement extends between the battery module and vehicle component to prevent movement of the battery module relative to the vehicle component.

19. A vehicle comprising:
an electric propulsion system;
a battery module;
a battery module bay adjacent to a vehicle component and configured to receive the battery module with a gap between the battery module and the vehicle component; and
a locking implement configured to move from a passive configuration to an active configuration in which the locking implement extends between the battery module and vehicle component to prevent movement of the battery module relative to the vehicle component.

20. The vehicle of claim 19, wherein:
the locking implement is configured to move from the active configuration to the passive configuration in which the locking implement is retracted out of the gap;
the locking implement is mounted to the vehicle component;
the vehicle component is a cross beam defining an interior volume and including an upper end;
the locking implement is located in the interior volume in the passive configuration;
the battery module includes a laterally-extending upper tab configured to sit on the upper end;
the locking implement comprises an implement actuator overlying the cross beam; and
the locking implement and implement actuator are rotatable about an axis parallel to the battery module bay.
